(19) United States
(12) Patent Application Publication
(10) Pub. No.: US 2007/0293262 A1
(43) Pub. Date: Dec. 20, 2007

(54) Apparatus and method for searching for base station of radio communication network

(75) Inventors: Shigeru Shibata, Kanagawa-ken (JP); Katsuyuki Arai, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/592,827

(22) Filed: Nov. 3, 2006

(30) Foreign Application Priority Data
Jun. 15, 2006 (JP) 2006-165834

(51) Int. Cl. H04M 1/00

(52) U.S. Cl. 455/550.1

(57) ABSTRACT

A radio communication apparatus for searching for a base station of a radio communication network is provided. The radio communication apparatus is configured to join a network including a plurality of base stations forming service coverage of radio communication. The radio communication apparatus includes an antenna and a radio circuit coupled to the antenna. The radio circuit is configured to send and receive a radio wave via the antenna to and from one of the base stations. The radio communication apparatus includes a controller coupled to the radio circuit and configured to start and stop an application other than the communication. The controller is configured to search for one of the base stations providing maximum signal strength by way of the antenna and the radio circuit after stopping the application.

### CROSS REFERENCE TO RELATED APPLICATIONS

This application is based upon and claims the benefit of priority from the prior Japanese Patent Application No. 2006-165834 filed on Jun. 15, 2006; the entire contents of which are incorporated herein by reference.

### FIELD OF THE INVENTION

The present invention relates to an apparatus and a method for searching for a base station of a radio communication network, and in particular to those relating to an application other than communication.

### DESCRIPTION OF THE BACKGROUND

In a radio communication network for mobile communication, a radio communication apparatus, e.g., a mobile phone, searches a neighborhood thereof for a base station to be selected for uplink and downlink communication in a good condition. In order that quality of the communication is kept above a necessary level, it is important that the radio communication apparatus properly search for and select the base station.

Specifically speaking, the radio communication apparatus periodically watches control channel signals coming from at least one of base stations located in the neighborhood while waiting for an incoming call. The radio communication apparatus then selects one of the base stations providing maximum signal strength so as to be connected by radio to the selected base station.

After being connected to the base station, the radio communication apparatus may continue communicating with the base station as long as the quality of communication is kept above the necessary level. The radio communication apparatus may thus be configured not to change the selection of the base station until the quality of communication lowers the necessary level, even if another base station could provide greater signal strength as the radio communication apparatus moves. As a result, there may be a problem that the radio communication apparatus does not optimize the quality of communication.

It could be a solution to the above problem that the radio communication apparatus is capable of searching for a base station providing maximum signal strength according to user's operation at any time even while waiting for an incoming call. An example of such kind of radio communication apparatus is disclosed in Japanese Patent Publication (Kokai), No. H11-243574, that is equipped with a key used for selecting base stations. If the key is pressed, even while being connected to a base station and waiting for an incoming call, the radio communication apparatus starts searching base stations located in its neighborhood for one of them providing maximum signal strength.

In recent years, an increasing number of radio communication apparatus may be used not only for communication such as voice calls, emails, web browsing, etc. but for other applications. For instance, the radio communication apparatus may include a built-in camera to take a picture or a video movie, may receive TV or radio broadcast by using a built-in broadcast receiver, may play music, and may manage a telephone directory or a schedule stored therein.

Assume that the radio communication apparatus is being able to communicate with no base stations and is out of service coverage of a network by, e.g., being overseas where there are no available communication services provided, and that the radio communication apparatus is being used for an application other than communication. If repeating searching for a base station in such a circumstance, the radio communication apparatus may end up wasting power and reducing battery endurance.

The radio communication apparatus could somehow avoid wasting power while being out of the service coverage and used for an application other than communication. An example of such kind of radio communication apparatus is disclosed in Japanese Patent Publication (Kokai), No. 2004-343383, that includes a radio portion and a baseband portion wherein the baseband portion may be used for an application other than communication. While being out of the service coverage, that radio communication apparatus keeps supplying the baseband portion with power and stops supplying the radio portion with power.

A radio communication apparatus having a liquid crystal display (LCD) like a usual mobile phone may display, on an area of the LCD, electric field strength of a radio wave received from a base station, i.e., received signal strength, and may display whether the radio communication apparatus is within or out of the service coverage. For instance, the radio communication apparatus may display an icon called a signal strength indicator on a top area of the LCD.

The signal strength indicator is typically formed by a symbol of an antenna and a couple of vertical bars arranged in order of lengths. The antenna symbol accompanying all of the vertical bars shows a state of full signal strength. The antenna symbol accompanying no vertical bars shows a state of out of the service coverage.

In addition to or instead of the signal strength indicator, the radio communication apparatus may display another symbol or a message that indicates a service coverage condition, i.e., whether the radio communication apparatus is within or out of the service coverage. The radio communication apparatus may not indicate the service coverage condition while being used for an application other than communication.

While being used for an application other than communication, e.g., using a camera or a broadcast receiver, the radio communication apparatus may experience deterioration of a carrier to noise ratio of a radio wave received from a base station to which the radio communication apparatus is connected due to noise generated by the camera or the broadcast receiver.

The above deterioration may cause a false indication of out of the service coverage on an LCD of the radio communication apparatus after the application finishes, although the radio communication apparatus is actually within the service coverage. The false indication of out of the service coverage may continue for a relatively long time until the radio communication apparatus completes a series of transactions with the base station to reopen a state of waiting for an incoming call, i.e., a call waiting state.

The false indication of out of the service coverage and its continuation before the call waiting state reopens as described above may be confusing or embarrassing from a viewpoint of user interface, and is therefore not desirable. Such a false indication of out of the service coverage should be avoided after an application other than communication finishes. The radio communication apparatus disclosed in the reference documents shown above may not avoid the false indication of out of the service coverage, as they do not control an indication of a service coverage condition.

### SUMMARY OF THE INVENTION

Accordingly, an advantage of the present invention is that a radio communication apparatus may avoid a false indication of out of service coverage after finishing an application other than communication.

To achieve the above advantage, one aspect of the present invention is to provide a radio communication apparatus configured to join a network including a plurality of base stations forming service coverage of radio communication. The radio communication apparatus includes an antenna and a radio circuit coupled to the antenna. The radio circuit is configured to send and receive a radio wave via the antenna to and from one of the base stations. The radio communication apparatus includes a controller coupled to the radio circuit and configured to start and stop an application other than the communication. The controller is configured to search for one of the base stations providing maximum signal strength by way of the antenna and the radio circuit after stopping the application.

### BRIEF DESCRIPTION OF THE DRAWINGS

FIG. 1 is an external view of a radio communication apparatus of an embodiment of the present invention.

FIG. 2 is a block diagram of the radio communication apparatus of the embodiment.

FIG. 3 is a flow chart of processing of the radio communication apparatus of the embodiment.

### DETAILED DESCRIPTION OF THE INVENTION

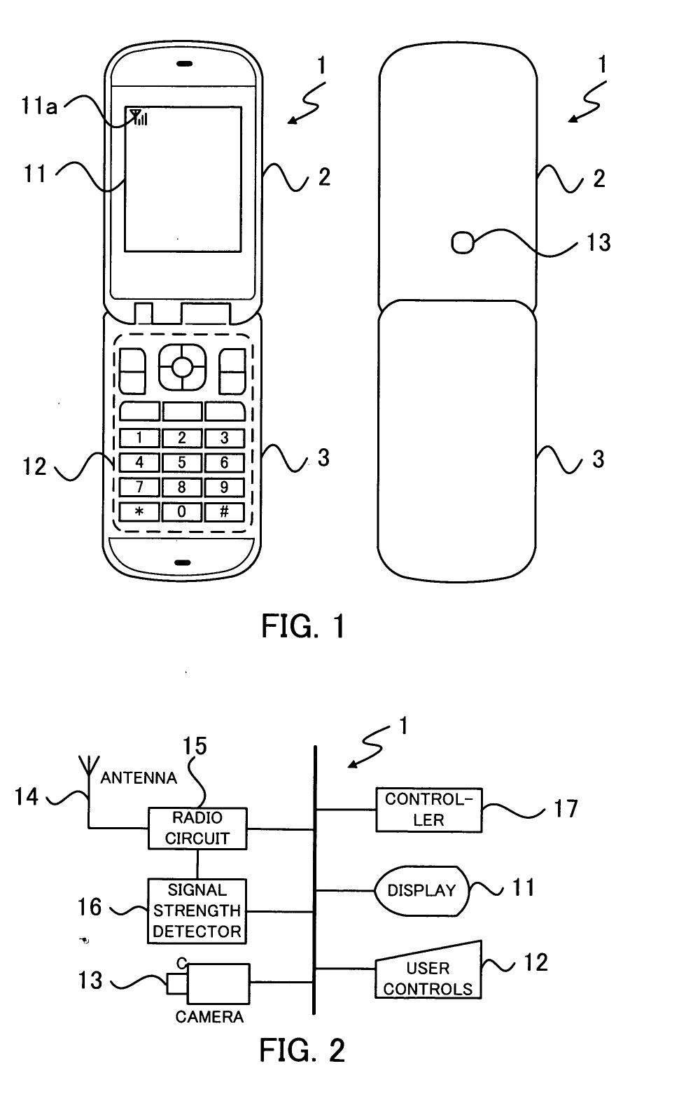

An embodiment of the present invention will be described with reference to FIGS. 1-3. FIG. 1 is an external view of a radio communication apparatus 1 of the embodiment of the present invention. The radio communication apparatus 1 is a clamshell type mobile phone. The radio communication apparatus 1 may be a mobile phone of another type, a personal digital assistant (PDA), a personal computer (PC) or another kind of apparatus capable of radio communication.

The radio communication apparatus 1 is configured to join a network (not shown) that provides radio communication services. The network includes a plurality of base stations (not shown) and provides service coverage formed by the base stations, i.e., a geographical area in which the radio communication apparatus 1 may be connected to one of the base stations by radio and may be used for communication.

The radio communication apparatus 1 is a clamshell type mobile phone including an upper case 2 and a lower case 3 movably connected to each other and forming a clamshell configured to be open or closed. On a left hand side of FIG. 1, shown is a front view of the radio communication apparatus 1 when the clamshell is open, where “front” means a user's side during a voice call or display monitoring.

On a front face of the upper case 2, provided is a display 11 formed by, e.g., a liquid crystal display device. On a front face of the lower case 3, provided is a set of user controls 12 including a plurality of keys which are shown surrounded by a dashed line. On an upper left portion of the display 11, displayed is a signal strength indicator 11a, an example of indicating a service coverage condition of the radio communication apparatus 1, i.e., whether the radio communication apparatus 1 is within or out of the service coverage. The signal strength indicator 11a varies its appearance depending on a value of signal strength.

On a right hand side of FIG. 1, shown is a back view of the radio communication apparatus 1 when the clamshell is open, where “back” means opposite of the front. On a back face of the upper case 2, provided is a camera 13.

FIG. 2 is a block diagram of the radio communication apparatus 1 including the display 11, the set of user controls 12 and the camera 13. In addition, the radio communication apparatus 1 includes an antenna 14, a radio circuit 15, a signal strength detector 16 and a controller 17. The antenna 14 may be used for sending and receiving radio waves to and from a base station (not shown) of the network which the radio communication apparatus 1 joins.

The antenna 14 is connected to the radio circuit 15 that is then connected to the signal strength detector 16. The display 11, the set of user controls 12, the camera 13, the radio circuit 15 and the signal strength detector 16 are connected to the controller 17 each. The controller 17 is formed by a processing device like a microprocessor or a digital signal processor. The controller 17 monitors and controls each portion and a whole of the radio communication apparatus 1.

The radio circuit 15 modulates a continuous frequency with an outgoing digital signal encoded with data provided by the controller 17. The radio circuit 15 up-converts and amplifies the modulated frequency so as to produce an outgoing radio wave. The radio circuit 15 provides the antenna 14 with the outgoing radio wave to emit to the base station (not shown).

From the base station, an incoming radio wave may arrive at the radio communication apparatus 1. The incoming radio wave is, via the antenna 14, received by the radio circuit 15. The received radio wave is then amplified and down-converted by the radio circuit 15 that demodulates an incoming digital signal carried by the incoming radio wave. The radio circuit 15 decodes the demodulated digital signal so as to reproduce data sent from the base station, and provides the controller 17 with the reproduced data.

Being connected to the radio circuit 15, the signal strength detector 16 may detect electric field strength of the incoming radio wave, i.e., received signal strength, and may provide the controller 17 with a detected value of the received signal strength. Being provided with the above detected value, the controller 17 may evaluate the detected value of the received signal strength, e.g., in three grades.

The controller 17 may display a result of the evaluation on the display 15 as, e.g., the signal strength indicator 11a shown in FIG. 1. The number of grades in which the received signal strength is evaluated is not limited to three. A lowest grade or detection of no signal corresponds to and is defined as the state of out of the service coverage. Instead of or in addition to the signal strength indicator 11a, the controller 17 may display a text message or another symbol on the display 11 saying that the radio communication apparatus 1 is within or out of the service coverage.

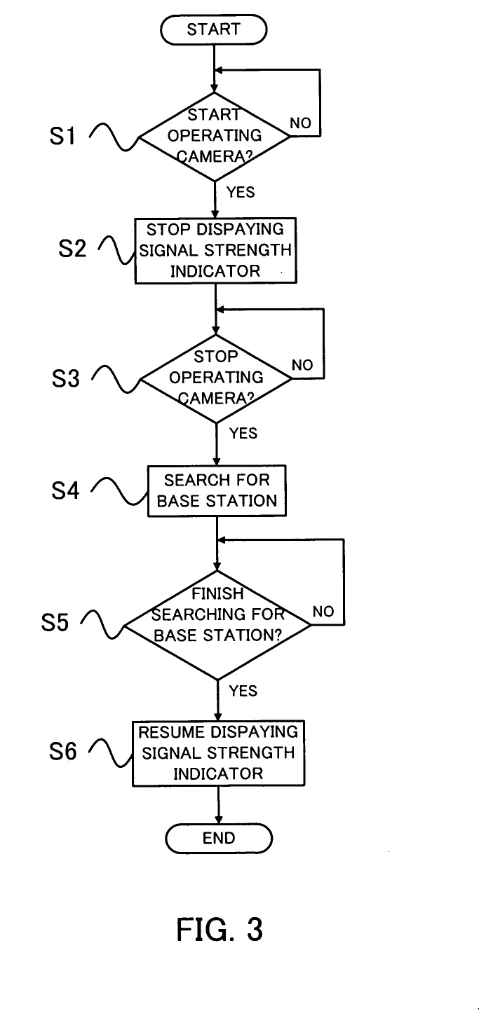

Operation of the radio communication apparatus 1 will be described with reference to FIG. 3, a flow chart of the operation. Assume that the radio communication apparatus 1 is connected by radio to a base station named FBS (first base station), and is waiting for an incoming call (call waiting state) after the operation starts (“START”).

Assume, in addition, that the controller 17 displays the signal strength indicator 11a on the display 11 indicating the signal strength of an incoming wave received from FBS and detected by the signal strength detector 16.

The controller 17 waits for at least one of the keys of the set of user controls 12 to be pressed so as to start operating the camera 13 (“NO” of step S1). If the camera 13 starts operating after the above camera starting operation (“YES” of step S1), the controller 17 stops displaying the signal strength indicator 11a on the display 11 (step S2).

The controller 17 waits for at least one of the keys included in the set of user controls 12 to be pressed so as to stop operating the camera 13 (“NO” of step S3). After the camera 13 stops operating (“YES” of step S3), the controller 17 searches a neighborhood of the radio communication apparatus 1 for a base station to be connected to by way of the radio circuit 15 and the antenna 14 (step S4). The signal strength detector 16 detects signal strength provided by each of at least one of base stations located in the neighborhood. The signal strength detector 16 provides the controller 17 with a detected value of the above signal strength.

Comparing the values of the signal strength provided by the base stations located in the neighborhood, the controller 17 may select one of the base stations that covers a current location of the radio communication apparatus 1 and provides maximum signal strength. Unless such a base station is detected, the controller 17 may determine that the radio communication apparatus 1 is out of the service coverage.

The controller 17 continues the above selection or determination process (“NO” of step S5) and finishes the above process according to a criterion. The base station selected in the above process may or may not equal FBS.

After finishing the above process (“YES” of step S5), the controller 17 resumes displaying the signal strength indicator 11a on the display 11 indicating one of the signal strength provided by the selected base station and the determination of out of the service coverage (step S6).

If the controller 17 successfully searches for and selects a base station at the step S4, the communication apparatus 1 may promptly resume displaying the signal strength indicator 11a to indicate the state of within the service coverage. This is smoother than a case where the communication apparatus 1 would get out of the state of out of the service coverage upon being instructed by FBS and completing a series of transactions with FBS to reopen the call waiting state.

As meaningless indication of out of the service coverage may be avoided after the application of using the camera 13 finishes due to the present invention, occurrence of confusion or embarrassment from a viewpoint of user interface may be less probable.

In the above description, the radio communication apparatus 1 has the camera 13, and the application of the radio communication apparatus 1 other than communication is the use of the camera 13. If the radio communication apparatus 1 has a receiver of broadcast (analog or digital, TV or radio, terrestrial or satellite), a received wave may act as noise and may cause a problem similar to that caused by the camera 13.

Therefore, the present invention may be implemented in a case where the application of the radio communication apparatus 1 other than communication is the use of the broadcast receiver. An indicator indicating the service coverage condition may not be limited to the signal strength indicator 11a, but may be another type of indicator. The indicator may or may not include a text message.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A radio communication apparatus configured to join a network including a plurality of base stations forming service coverage of radio communication, the radio communication apparatus comprising:
an antenna;
a radio circuit coupled to the antenna, the radio circuit configured to send and receive a radio wave via the antenna to and from one of the base stations; and
a controller coupled to the radio circuit, the controller configured to start and stop an application other than the communication, the controller configured to search for one of the base stations providing maximum signal strength by way of the antenna and the radio circuit after stopping the application.

2. The radio communication apparatus of claim 1, further comprising a display coupled to the controller, wherein
the controller is further configured to display an indicator on the display indicating whether the radio communication apparatus is within or out of the service coverage, the controller further configured to stop displaying the indicator upon starting the application and to resume displaying the indicator upon stopping the application.

3. The radio communication apparatus of claim 1, further comprising a camera coupled to the controller, wherein the application is use of the camera.

4. The radio communication apparatus of claim 1, further comprising a display and a camera coupled to the controller each, wherein
the controller is further configured to display an indicator on the display indicating whether the radio communication apparatus is within or out of the service coverage, the controller further configured to stop displaying the indicator upon starting the application and to resume displaying the indicator upon stopping the application, and the application is use of the camera.

5. The radio communication apparatus of claim 1, further comprising a broadcast receiver coupled to the controller, wherein the application is use of the broadcast receiver.

6. The radio communication apparatus of claim 1, further comprising a display and a broadcast receiver coupled to the controller each, wherein
the controller is further configured to display an indicator on the display indicating whether the radio communication apparatus is within or out of the service coverage, the controller further configured to stop displaying the indicator upon starting the application and to resume displaying the indicator upon stopping the application, and the application is use of the broadcast receiver.

7. A method for searching for one of a plurality of base stations of a network, the base stations forming service coverage of radio communication, the method comprising:
starting an application of a radio communication apparatus configured to join the network, the application being other than the communication; and
searching for one of the base stations providing the radio communication apparatus with maximum signal strength upon stopping the application.

8. The method of claim 7, further comprising displaying an indicator on a display of the radio communication apparatus, the indicator indicating whether the radio communication apparatus is within or out of the service coverage,
stopping displaying the indicator upon starting the application, and resuming displaying the indicator upon stopping the application.

9. The method of claim 7, wherein the application is use of a camera of the radio communication apparatus.

10. The method of claim 7, wherein the application is use of a broadcast receiver of the radio communication apparatus.
